(19) United States
(12) Patent Application Publication
(10) Pub. No.: US 2023/0292783 A1
(43) Pub. Date: Sep. 21, 2023

(54) METHOD FOR REDUCING SULFUR-CONTAINING-COMPOUND CONTENT OF VOLATILE SUBSTANCES FROM FRIED FOOD

(71) Applicant: J-OIL MILLS, INC., Tokyo (JP)

(72) Inventors: Yuki OKAMOTO, Tokyo (JP); Ko KIMURA, Tokyo (JP); Ryohei WATANABE, Tokyo (JP); Rina SHIMIZU, Tokyo (JP); Masami INOUE, Tokyo (JP)

(21) Appl. No.: 18/021,482

(22) PCT Filed: Aug. 17, 2021
(86) PCT No.: PCT/JP2021/030050

§ 371 Date: Feb. 15, 2023

(30) Foreign Application Priority Data
Aug. 31, 2020 (JP) 2020-145589

(51) Int. Cl. A23D 9/02; A23L 5/10

(52) U.S. Cl. CPC A23D 9/02; A23L 5/11

(57) ABSTRACT

An object of the invention is to provide a method for reducing the sulfur-containing-compound content of volatile substances from fried food.

The invention provides a method for reducing the sulfur-containing-compound content of volatile substances from fried food, wherein a foodstuff is fried using an oil and fat composition containing an edible oil and fat and the following component A. Component A: One, two, or more oils and fats selected from (1) to (5). (1) A roasted oil, (2) a decoction oil, (3) an n-3 edible oil and fat, (4) an overheated oil, (5) olive oil.

### TECHNICAL FIELD

The present invention is a method for reducing the sulfur-containing-compound content of volatile substances from fried food.

### BACKGROUND ART

In general, one of the aromas of fried food derives from volatile substances generated by cooking. Many studies have been conducted to improve the flavor of food using volatile substances generated during cooking; for example, Patent Document 1 indicates that D-psicose, one of the rare sugars, is added to food to give the food a fragrant and sweet aroma when heated.

In addition, it is known conventionally that the compositions of oil and fat compositions used for frying affect the flavor of fried food. For example, Patent Document 2 indicates that the oiliness of fried food is reduced by frying using an oil and fat composition containing unrefined olive oil.

Therefore, the inventors studied the relationship between compositions of oil and fat compositions used in frying and volatile substances from fried food. Oil and fat compositions having various compositions were used in frying, and the volatile substances generated from the fried foods were trapped, analyzed, and evaluated. As a result, it was found that some sulfur-containing compounds have an undesirable effect on flavor.

### RELATED ART DOCUMENTS

### Patent Documents

[Patent Document 1] Japanese Laid-Open Patent Application No. 2008-048685
[Patent Document 2] Japanese Laid-Open Patent Application No. 2019-004829

### DISCLOSURE OF THE INVENTION

### Problems the Invention is Intended to Solve

Patent Documents 1 and 2 do not disclose or suggest reducing the sulfur-containing-compound content of volatile substances from fried food by frying using an oil and fat composition to which a specific component has been added.

It is therefore an object of the present invention to provide a method for reducing the sulfur-containing-compound content of volatile substances from fried food.

### Means for Solving the Problems

As a result of thoroughgoing studies, the inventors perfected the present invention by discovering that by frying a foodstuff using an oil and fat composition containing a specific component and an edible oil and fat, there will be a reduction in the sulfur-containing-compound content of the volatile substances generated from fried food.

The present invention is configured as indicated below.

[1]

A method for reducing the sulfur-containing-compound content of volatile substances from fried food, wherein a foodstuff is fried using an oil and fat composition containing an edible oil and fat and the following component A.

Component A: One, two, or more oils and fats selected from (1) to (5) below.
(1) A Roasted Oil
(2) An oil and fat obtained through a production method including an addition step in which one, two, or more selected from oil stuff raw materials and products processed from the oil stuff raw materials are added to an edible oil and fat, and a heating step in which the oil and fat is heated at a heating temperature of more than 100° C. and 220° C. or less and for a heating time of 5 minutes or more and 240 minutes or less
(3) An oil and fat in which the amount of n-3 fatty acids contained in the total amount of constituent fatty acids is 30% by mass or more and 80% by mass or less
(4) An oil and fat obtained by performing a heat treatment of 120° C. or more on crude oil including either expressed oil of corn germ or extracted oil of corn germ, or on an oil and fat obtained via at least one step among a degumming step, a deacidification step, and a decolorization step in a step of refining the crude oil
(5) Olive oil
   [2]

The reduction method wherein the component A is the oil and fat of (1), and the component A content is 0.05% by mass or more and 3% by mass or less.

[3]

The reduction method wherein the component A is the oil and fat of (2), and the component A content is 0.15% by mass or more and 6% by mass or less.

[4]

The reduction method wherein the component A is the oil and fat of (3), and the component A content is 0.1% by mass or more and 5% by mass or less.

[5]

The reduction method wherein the component A is the oil and fat of (4), and the component A content is 0.15% by mass or more and 6% by mass or less.

[6]

The reduction method wherein the component A is the oil and fat of (5), and the component A content is 1% by mass or more and 15% by mass or less.

[7]

The reduction method wherein the sulfur-containing compound is one, two, or more selected from methanethiol, 1,2-dimethyl sulfide, dimethyl trisulfide, dipropyl disulfide, dipropyl trisulfide, methional, allyl mercaptan, allyl disulfide, methyl 2-propenyl disulfide, and methyl 2-propenyl trisulfide.

[8]

The reduction method wherein the foodstuff includes one, two, or more selected from livestock meat, fish meat, vegetable protein, vegetables, and products processed therefrom.

### Effect of the Invention

According to the present invention, it is possible to reduce the sulfur-containing-compound content of volatile substances from fried food.

### MODE FOR CARRYING OUT THE INVENTION

A specific embodiment for carrying out the present invention shall be described. The description below is merely one aspect and does not limit the invention.

The present invention is a method for reducing the sulfur-containing-compound content of volatile substances from fried food (hereinafter sometimes simply referred to as “the reduction method”), characterized in that a foodstuff is fried using an oil and fat composition containing an edible oil and fat and component A.

In the present specification, the term “volatile substance from fried food” means volatile substances generated from fried food obtained by frying food materials and products processed therefrom with oil and fat compositions, and volatile substances generated from oil and fat compositions adhering to the fried foods.

Possible examples of the sulfur-containing compound include methanethiol, 1,2-dimethyl sulfide, dimethyl trisulfide, dipropyl disulfide, dipropyl trisulfide, methional, allyl mercaptan, allyl disulfide, methyl 2-propenyl disulfide, methyl 2-propenyl trisulfide, dimethyl disulfide, allyl isothiocyanate, 3-methyl-2-butene-1-thiol, 3-methyl-2-butanethiol, 3-methyl-1-butanethiol, 2-methyl-1-butanethiol, furfuryl mercaptan, etc.

Common “odors” of sulfur-containing compounds detected in volatile substances from fried food are described below.
Methanethiol: rotten onion
1,2-Dimethyl sulfide: rotten cabbage, seaweed
Dimethyl trisulfide: fresh onion
Dipropyl disulfide: raw onion
Dipropyl trisulfide: raw onion
Methional: caramel
Allyl mercaptan: garlic
Allyl disulfide: garlic
Methyl 2-propenyl disulfide: garlic
Methyl 2-propenyl trisulfide: garlic

[Method for Trapping Volatile Substance]

Volatile substances from fried food can be trapped via the following method.

(Trapping Agent)
Trapping agent: Monotrap RGPS TD (GL Sciences)

(Trapping Procedure)
1) Fried food is placed in a plastic Tupperware container together with two trapping agents five minutes after the food has been fried.
2) The container is left at room temperature (25° C.) for 2 hours.
3) The trapping agents are recovered, water is removed using a paper towel, and the trapping agents are sealed in a glass vial and stored until being used for analysis.

[Method for Analyzing Volatile Substance]

A sulfur-containing compound included in the volatile substance can be measured by GC-MS analysis.

(Analysis equipment and measurement conditions)

Conditions other than those in the columns listed below conform to MMSE described in “Silica monolith trapping agent Monotrap®, March 2018 revision” published by GL Sciences.
Column: DB-WAX UI, 0.25 μm, 0.25 mm×60 m (Agilent Technologies

(Measurement Procedure)
1) The two trapping agents obtained according to “Method for trapping volatile substance” above are placed in a glass insert for measurement, and a volatile substance is measured by thermal desorption.
2) After the measurement, a sulfur-containing compound estimated by library search using analysis software is extracted, and an area value of a TIC chromatogram of the sulfur-containing compound is obtained.

There are no particular limitations as to the edible oil and fat; possible examples include: vegetable oils such as rapeseed oil, corn oil, soybean oil, palm olein, sesame oil, rice bran oil, peanut oil, safflower oil, sunflower oil, cottonseed oil, grapeseed oil, macadamia nut oil, hazelnut oil, walnut oil, pumpkin seed oil, camellia oil, tea seed oil, olive oil, wheat germ oil, palm oil, palm kernel oil, coconut oil, and cocoa butter; animal oils and fats such as beef tallow, lard, chicken fat, milk fat, and fish oil; and synthetic oils such as medium-chain fatty acid triglycerides. In addition, these oils and fats can be processed oils and fats that have been subjected to one, two, or more treatments selected from curing, fractionation, and transesterification. These edible oils and fats may be used singly or in combination of two or more.

From the viewpoint of reducing the sulfur-containing-compound content of the volatile substance from the fried food, the edible oil and fat is preferably a vegetable oil such as soybean oil, rapeseed oil, corn oil, and palm oil, more preferably soybean oil and rapeseed oil, and even more preferably soybean oil. These edible oils and fats may be used singly or in combinations of two or more.

Component A is one or more oils and fats selected from (1) to (5) below. When multiple oils and fats are used in combination, two or more of the same group may be combined, or two or more may be selected from different groups and combined.
(1) A roasted oil
(2) An oil and fat obtained through a production method including an addition step in which one, two, or more selected from oil stuff raw materials and products processed from the oil stuff raw materials are added to an edible oil and fat, and a heating step in which the oil and fat is heated at a heating temperature of more than 100° C. and 220° C. or less and for a heating time of 5 minutes or more and 240 minutes or less
(3) An oil and fat in which the amount of n-3 fatty acids contained in the total amount of constituent fatty acids is 30% by mass or more and 80% by mass or less
(4) An oil and fat obtained by performing a heat treatment of 120° C. or more on crude oil including either expressed oil of corn germ or extracted oil of corn germ, or on an oil and fat obtained via at least one step among a degumming step, a deacidification step, and a decolorization step in a step of refining the crude oil.
(5) Olive oil

The oils and fats of (1) to (5) are described in detail below.

[Oil and Fat of (1)]

A roasted oil is an edible oil and fat obtained by expression, extraction, or the like after roasting an oil stuff raw material.

There are no particular limitations as to the oil stuff raw material; any material from which edible fats and oils can be collected can be used. Possible examples include corn germ (corn wet germ, corn dry germ), soybean, rapeseed, cotton seed, rice bran, sesame, olive, sunflower, perilla, linseed, pumpkin, almond, peanut, safflower, oil palm, palm, cocoa, grape seed, macadamia nut, hazelnut, walnut, camellia seed, tea seed, wheat germ, and the like. Corn germ, soybean, rapeseed, cotton seed, rice bran, sesame, olive, sunflower, perilla, and linseed are preferred, and corn germ is more preferred. One of these oil stuff raw materials may be used singly, or two or more may be used in combination.

Corn wet germ is obtained by fractionating corn kernels through a process called wet milling. As an example of this process, first, the corn kernels are soaked in a dilute sulfurous acid solution for about 48 hours to swell the corn kernels. As a result of this immersion, the albumen takes on moisture and settles in the lower part, and the germ, which contains a large amount of oil, gathers in the upper part. The germ collected at the upper part is then recovered due to a difference in specific gravity. Corn wet germ is obtained by drying the collected germ. The corn wet germ obtained is roasted without grinding. There are no particular limitations as to the roasting method, and the corn wet germ can be roasted by being heated from the outside via electric heat, hot air, a burner, microwaves, or the like.

Conditions for obtaining common roasted oil can be adopted as the roasting conditions. For example, it is preferable to employ the following roasting temperature and roasting time.
Roasting temperature: preferably 95° C. or higher and 200° C. or lower, more preferably 110° C. or higher and 180° C. or lower, even more preferably 120° C. or higher and 180° C. or lower, even more preferably 140° C. or higher and 180° C. or lower, and even more preferably 140° C. or higher and 165° C. or lower. Moreover, the roasting temperature in the present invention means the average temperature in a state of having reached 95° C. or higher and 200° C. or lower. In addition, the temperature during roasting may be within the above range and does not need to be kept constant.
Roasting time: preferably more than 0 minutes and 90 minutes or less, more preferably 3 minutes or more and 90 minutes or less, even more preferably 5 minutes or more and 90 minutes or less, even more preferably 5 minutes or more and 60 minutes or less. The roasting time in the present invention means the time during which the temperature reaches 95° C. or higher and 200° C. or lower.

For the roasting conditions, a value calculated by the following formula (I) is preferably 52 or greater and 230 or less, more preferably 52 or greater and 180 or less, and even more preferably 80 or more and 115 or less.

(T_{I}−100)×T_{I}^{0.2} (I)

In the above formula (I), T_{I} indicates the roasting temperature (° C.) and t_{I} indicates the roasting time (minutes).

[Oil and Fat of (2)]

The edible oils and fats described above can be used as the edible oil and fat. The edible oil and fat is preferably a vegetable oil such as soybean oil, rapeseed oil, corn oil, and palm oil. The edible oils and fats may be used singly or in a mixture of two or more. Corn oil, soybean oil, and rapeseed oil are preferred, and corn oil is particularly preferred, from the viewpoint of reducing the sulfur-containing-compound content of volatile substances from fried food.

There are no particular limitations as to the oil stuff raw material; for example, those listed in “Oil and fat of (1)” can be used. Preferred examples are corn germ, soybean, rapeseed, cottonseed, rice bran, sesame, olive, sunflower, perilla, and linseed, more preferred examples are corn wet germ, rapeseed, cottonseed, sesame and linseed.

Products processed from oil stuff raw materials include crushed oil stuff raw materials (cracked), pomace, and roasted products (roasted). Cracked soybean, rapeseed pomace, cottonseed pomace, olive pomace, and roasted linseed are preferred. One of these processed products may be used singly, or two or more may be used in a mixture. “Pomace” means a solid residue obtained after squeezing oil and fat from an oil stuff raw material.

The production method involves performing an addition step of, for example, adding the one, two, or more items selected from the oil stuff raw material and the processed products to the oil and fat so that the total mass of the oil stuff raw material and the processed product is 0.05 times or more and 1 times or less with respect to the mass of the oil and fat. Next, a heating step is performed in which the oil and fat including the oil stuff raw material and the processed product are heated under conditions satisfying formula (II) below, using a heating temperature of more than 100° C. and 220° C. or less and for a heating time of 5 minutes or more and 240 minutes or less.

85−6000/(270−T_{II})<t_{II}<240 (II)

(In formula (II) above, T_{II} is the heating temperature (° C.) and t_{II} is the heating time (minutes). 85−6000/(270−T_{II}) is taken to be “5” when calculated to be “less than 5.”)

After the heating step, a removal step is performed in which solids are removed by a method of filtration (pressurization, pressure reduction, suction, natural, centrifugation, or the like). If necessary, the oil and fat is then subjected to a degumming step of being degummed, a deacidification step of being deacidificated, a decolorization step of being decolorized, and a deodorization step of being deodorized. For the degumming step, deacidification step, decolorization step and deodorization step, methods used in common edible oil and fat refining steps can be employed. The obtained oil and fat of (2) may hereinafter be referred to simply as “decoction oil.” From the viewpoint of reducing the sulfur-containing-compound content of volatile substances from fried food, it is preferable that the decoction oil has undergone at least a deodorization step.

[Oil and Fat of (3)]

The term “n-3 edible oil and fat” refers to an edible oil and fat that contains a large amount of n-3 (omega-3) fatty acid that has unsaturated bonds in the 3rd and 4th carbon chains from the methyl group at the n-terminal of the fatty acid constituting the oil.

The amount of n-3 fatty acids contained in the total amount of constituent fatty acids can be measured according to, for example, “Standard Fat Analysis Test Method 2.4.1.4-2013” established by the Japan Oil Chemists' Society. Examples of n-3 fatty acids include α-linolenic acid, docosahexaenoic acid (DHA), eicosapentaenoic acid (EPA), docosapentaenoic acid (DPA), stearidonic acid, and the like, and n-3 fatty acids are usually composed of a plurality of types. Therefore, the n-3 fatty acid content is the total amount contained of these n-3 fatty acids.

In the present invention, the n-3 fatty acid content in the total amount of constituent fatty acids is 30% by mass or more and 80% by mass or less, preferably 35% by mass or more and 75% by mass or less, more preferably 40% by mass or more and 70% by mass or less, and even more preferably 50% by mass or more and 60% by mass or less.

More specifically, the n-3 edible oils and fats are, for example, perilla oil, linseed oil, Japanese basil oil, oils and fats (fish oils) containing docosahexaenoic acid (DHA), oils and fats (fish oils) containing eicosapentaenoic acid (EPA), chia seed oil, algae oil, microbial oil, and the like. Perilla oil, linseed oil, Japanese basil oil, oils and fats containing DHA, and oils and fats containing EPA are preferred, and perilla oil and linseed oil are more preferred. One of these n-3 edible fats and oils may be used singly, or a mixture of two or more may be used.

[Oil and Fat of (4)]

The oil and fat of (4) is overheated oil and fat obtained by carrying out an overheat treatment at 120° C. or more on crude oil containing either or both of expressed oil from corn germ and extracted oil from corn germ, or on oil and fat that has undergone at least one of a degumming step, deacidification step, and decolorization step in the crude oil refining step. Heated oil that has undergone this overheat treatment may hereinafter be referred to simply as “overheated oil.” This oil is preferably overheated oil obtained by carrying out the overheat treatment on the crude oil or on oil and fat that has undergone a degumming step and a deacidification step, or a degumming step and a decolorization step in the step of refining the crude oil, and is more preferably overheated oil obtained by carrying out a refining step after the overheat treatment.

The term “overheat treatment” means, for example, a heat treatment performed in a higher temperature than a heat treatment at about 100° C. performed in the refining step of refining the crude oil. In the present specification, the term “overheat treatment” is used to distinguish from a heat treatment at about 100° C.

Expressed oil and extracted oil can be obtained by employing common edible oil and fat expressing and extraction methods.

For the degumming step, deacidification step, and decolorization step, methods used in a common edible oil and fat refining step can be employed.

In the step of the overheat treatment, the heating temperature is 120° C. or higher, preferably 130° C. or higher and 220° C. or lower, and more preferably 130° C. or higher and 190° C. or lower. The overheat treatment is preferably carried out under the conditions obtained by the following formula (III).

35≤(T_{III}−100)×t_{III}^{0.2}≤270 (III)

(In formula (III) above, Till is the heating temperature (° C.) and till is the overheat treatment time (minutes)).

In the overheat treatment step, if the heating temperature is 140° C. or higher, the heating may be performed until at least that temperature is reached, in which case t_{III} may be a time close to 0 without limit. Therefore, the condition of the following formula (III) need not be satisfied. Moreover, the term “overheat treatment time” means the time during which the oil and fat is practically maintained at that temperature after the oil and fat is heated to reach the overheat treatment temperature.

[Oil and Fat of (5)]

This oil and fat is obtained from olives by expressing, extraction, or the like. Unrefined olive oil and refined olive oil that has undergone a normal refining process can be used. From the viewpoint of reducing the sulfur-containing-compound content of volatile substances from fried food, unrefined olive oil is preferable.

The reduction method is characterized in that a foodstuff is fried using an oil and fat composition containing component A described above and an edible oil and fat.

The amount of the oil and fat of (1) to (5) contained in the oil and fat composition shall be described.

The amount of the oil and fat of (1) contained in the oil and fat composition is preferably 0.05% by mass or more and 3% by mass or less, more preferably 0.1% by mass or more and 3% by mass or less, and even more preferably 0.1% by mass or more and 2% by mass or less.

The amount of the oil and fat of (2) contained in the oil and fat composition is preferably 0.15% by mass or more and 6% by mass or less, more preferably 0.3% by mass or more and 6% by mass or less, and even more preferably 0.3% by mass or more and 4% by mass or less.

The amount of the oil and fat of (3) contained in the oil and fat composition is preferably 0.1% by mass or more and 5% by mass or less, more preferably 0.4% by mass or more and 5% by mass or less, and even more preferably 0.4% by mass or more and 3% by mass or less.

The amount of the oil and fat of (4) contained in the oil and fat composition is preferably 0.15% by mass or more and 6% by mass or less, more preferably 0.3% by mass or more and 6% by mass or less, and even more preferably 0.3% by mass or more and 4% by mass or less.

The amount of the oil and fat of (5) contained in the oil and fat composition is preferably 1% by mass or more and 15% by mass or less, more preferably 4% by mass or more and 15% by mass or less, and even more preferably 4% by mass or more and 10% by mass or less.

The total amount of component A contained in the oil and fat composition is preferably 0.05% by mass or more and 15% by mass or less, more preferably 0.1% by mass or more and 15% by mass or less, and even more preferably 0.1% by mass or more and 10% by mass or less.

The oils and fats of (1) to (5) may be used singly or in combinations of two or more within the same group, or two or more may be selected from among different groups and used in combination.

Examples of the foodstuffs include foodstuffs such as livestock meat, fish meat, vegetable proteins, vegetables, shellfish, algae, and fruits, and products processed from these foodstuffs. These foodstuffs may be used singly or in combinations of two or more. From the viewpoint of reducing the sulfur-containing-compound content of volatile substances from fried food, the foodstuff is preferably one or more selected from livestock meat, fish meat, vegetables, and products processed therefrom.

Frying is a heat cooking method using a relatively large amount of an oil and fat composition as a heating medium, such as frying, deep-frying, tempura, and frying in batter. There are no particular limitations as to the frying method; for example, the foodstuff is immersed in an oil and fat composition heated to 140° C. or higher and 200° C. or lower to heat cook the food.

### EXAMPLES

An example of the method of the present invention for reducing the sulfur-containing-compound content of volatile substances from fried food shall be described below.

The oils and fats used in the following examples are listed below.

[Edible Oils and Fats]

Soybean oil: J soybean white squeezed oil (J-Oil Mills, Inc.)

Rapeseed oil: J canola (J-Oil Mills, Inc.)

[Component A]

Oil and fat of (1): roasted corn oil. Corn wet germ (Ota Oil Co., Ltd.) was introduced into a heater provided with a stirrer heated to a starting roasting temperature of 150° C., and roasted at 155° C. for 30 minutes (value of formula (I) is 109). The corn wet germ was then expressed using an expeller to recover the oil. The recovered oil was filtered and then degummed to obtain roasted corn oil.

Oil and fat of (2): decoction corn oil. 45 parts by mass of corn wet germ (Ota Oil Co., Ltd.) was added to 55 parts by mass of corn oil, heated at 180° C. for 60 minutes, and then filtered and degummed to obtain decoction corn oil.

Oil and fat of (3): linseed oil, refined linseed oil (Ota Oil Co., Ltd.). Regarding the n-3 fatty acid content in the total amount of constituent fatty acids, the α-linolenic acid content was 54.5% by mass, and EPA and DHA were not detected.

Oil and fat of (3): perilla oil, refined perilla oil (Ota Oil Co., Ltd.). Regarding the n-3 fatty acid content in the total amount of constituent fatty acids, the α-linolenic acid content was 58% by mass, and EPA and DHA were not detected.

Oil and fat of (4): overheated corn oil. Expressed corn oil (J-Oil Mills, Inc.) was overheated at 180° C., and was then subjected to degumming, deacidification, and decolorization to obtain overheated corn oil.

Oil and fat of (5): Unrefined olive oil (Aceites del Sur-coosur, S.A.)

Foodstuffs used for frying in the examples and the methods for cooking the foodstuffs are listed below.

[Pork Cutlet]

Foodstuff: Soft Pork Cutlet 160 (Ajinomoto Frozen Foods Co., Inc.)

Cooking method: One pork cutlet was fried for 8 minutes with 1 kg of an oil and fat composition heated to 185° C. to obtain a fried pork cutlet.

[Potato Croquette]

Foodstuff: New potato croquette 60 (Ajinomoto Frozen Foods Co., Inc.)

Cooking method: Two potato croquettes were fried using 1 kg of an oil and fat composition heated to 180° C. for 5 minutes and 30 seconds to obtain fried potato croquettes.

[Kara-Age]

Foodstuff: Chicken kara-age (Ajinomoto Frozen Foods Co., Inc.)

Cooking method: Two pieces of kara-age were fried for 4 minutes and 30 seconds using 1 kg of an oil and fat composition heated to 180° C. to obtain fried kara-age.

[Method for Evaluating Sulfur-Containing Compounds]

The fried foods were subjected to the “Method for collecting volatile substances” and “Method for analyzing volatile substances” described above to obtain an area value of the sulfur-containing-compound content of volatile substances. In evaluating the sulfur-containing compound, the area value of the sulfur-containing compound included in a volatile substance generated from fried food fried only with an edible oil and fat was used as the “control” area value of the sulfur-containing compound, and the rate of increase in the area value of the sulfur-containing compound included in the volatile substance generated from the fried food that was fried using the method of the present invention was calculated. In the evaluation results, a calculated value of less than 1 indicates that an effect is present in which the sulfur-containing-compound content is lower than in the control example. In each table, “-” indicates that the target sulfur-containing compound was not detected. The obtained evaluation results are described below.

[Flavor Evaluation Method]

The fried foods were evaluated to determine if their flavor was preferable to that of the control. The evaluation was performed by one expert panelist trained to evaluate flavor.

### Examples 1-1 to 1-3

Table 1 shows the components of the oil and fat compositions of Examples 1-1 to 1-3 and evaluation results.

TABLE 1

| | | Control | | | |
|---|---|---|---|---|---|
| | | Ex. 1-1 | Ex. 1-1 | Ex. 1-2 | Ex. 1-3 |
| Foodstuff | | Pork cutlet | | | |
| Edible oil | Soybean oil | 100 | 99.6 | 99.2 | 99.2 |
| and fat | | | | | |
| (mass %) | | | | | |
| Component A | Oil and fat | | 0.4 | | |
| (mass %) | of (1) | | | | |
| | roasted corn | | | | |
| | oil | | | | |
| | Oil and fat | | | 0.8 | |
| | of (3) | | | | |
| | linseed oil | | | | |
| | Oil and fat | | | | 0.8 |
| | of (3) | | | | |
| | perilla oil | | | | |

| | | | | |
|---|---|---|---|---|
| Dimethyl trisulfide | Control | 0.10 | 0.18 | 0.18 |
| Flavor evaluation | | Had | Had | Had |
| | | desirable | desirable | desirable |
| | | flavor | flavor | flavor |

As shown in Table 1, by frying pork cutlets using the oil and fat compositions of Examples 1-1 to 1-3 containing the oil and fat of (1) or the oil and fat of (3) as component A, the amount of dimethyl trisulfide was lower than Control Example 1-1.

For the oil and fat of (1), an effect of reducing the sulfur-containing-compound content was obtained by including 0.4% by mass of roasted corn oil in the oil and fat composition.

For the oil and fat of (3), an effect of reducing the sulfur-containing-compound content was obtained by including 0.8% by mass of linseed oil or perilla oil in the oil and fat composition.

In the flavor evaluation as well, the pork cutlets fried using the oil and fat compositions of Examples 1-1 to 1-3 all had flavor preferable to Control Example 1-1.

### Examples 2-1 and 2-2

Table 2 shows the contents of the oil and fat compositions of Examples 2-1 and 2-2 and evaluation results.

TABLE 2

| | | Control | | |
|---|---|---|---|---|
| | | Ex. 2-1 | Ex. 2-1 | Ex. 2-2 |
| Foodstuff | | Pork cutlet | | |
| Edible oil | Soybean oil | 50 | 50 | 50 |
| and fat | Rapeseed oil | 50 | 49.6 | 49.2 |
| (mass %) | | | | |
| Component A | Oil and fat | | 0.4 | |
| (mass %) | of (1) | | | |
| | roasted corn | | | |
| | oil | | | |
| | Oil and fat | | | 0.8 |
| | of (3) | | | |
| | linseed oil | | | |

| | | | |
|---|---|---|---|
| Methanethiol | Control | 0.42 | 0.41 |
| 1,2-Dimethyl sulfide | | 0.79 | 0.77 |
| Dimethyl trisulfide | | 0.67 | — |
| Flavor evaluation | | Had | Had |
| | | desirable | desirable |
| | | flavor | flavor |

As shown in Table 2, by frying pork cutlets using the oil and fat compositions of Examples 2-1 and 2-2 containing the oil and fat of (1) or the oil and fat of (3) as component A, the amounts of methanethiol, 1,2-diemthyl sulfide, and dimethyl trisulfide were lower than Control Example 2-1.

For the oil and fat of (1), an effect of reducing the sulfur-containing-compound content was obtained by including 0.4% by mass of roasted corn oil in the oil and fat composition.

For the oil and fat of (3), an effect of reducing the sulfur-containing-compound content was obtained by including 0.8% by mass of linseed oil in the oil and fat composition.

In the flavor evaluation as well, the pork cutlets fried using the oil and fat compositions of Examples 2-1 and 2-2 both had desirable flavor in comparison to Control Example 2-1.

### Examples 3-1 and 3-2

Table 3 shows the contents of the oil and fat compositions of Examples 3-1 and 3-2 and evaluation results.

TABLE 3

| | | Control | | |
|---|---|---|---|---|
| | | Ex. 3-1 | Ex. 3-1 | Ex. 3-2 |
| Foodstuff | | Potato croquette | | |
| Edible oil | Soybean oil | 50 | 50 | 50 |
| and fat | Rapeseed oil | 50 | 49.6 | 49.2 |
| (mass %) | | | | |
| Component A | Oil and fat | | 0.4 | |
| (mass %) | of (1) | | | |
| | roasted corn | | | |
| | oil | | | |
| | Oil and fat | | | 0.8 |
| | of (3) | | | |
| | linseed oil | | | |

| | | | |
|---|---|---|---|
| Methanethiol | Control | 0.16 | 0.18 |
| Dipropyl trisulfide | | 0.79 | — |
| Flavor evaluation | | Had | Had |
| | | desirable | desirable |
| | | flavor | flavor |

As shown in Table 3, by frying potato croquettes with the oil and fat compositions of Examples 3-1 and 3-2 containing the oil and fat of (1) or the oil and fat of (3) as component A, the amounts of methanethiol and dipropyl trisulfide were lower than Control Example 3-1.

For the oil and fat of (1), an effect of reducing the sulfur-containing-compound content was obtained by including 0.4% by mass of roasted corn oil in the oil and fat composition.

For the oil and fat of (3), an effect of reducing the sulfur-containing-compound content was obtained by including 0.8% by mass of linseed oil in the oil and fat composition.

In the flavor evaluation as well, the potato croquettes fried using the oil and fat compositions of Examples 3-1 and 3-2 both had flavor preferable to Control Example 3-1.

### Examples 4-1 and 4-2

Table 4 shows the contents of the oil and fat compositions of Examples 4-1 and 4-2 and evaluation results.

TABLE 4

| | | Control | | |
|---|---|---|---|---|
| | | Ex. 4-1 | Ex. 4-1 | Ex. 4-2 |
| Foodstuff | | Kara-age | | |
| Edible oil | Soybean oil | 50 | 50 | 50 |
| and fat | Rapeseed oil | 50 | 49.6 | 49.2 |
| (mass %) | | | | |
| Component A | Oil and fat | | 0.4 | |
| (mass %) | of (1) | | | |
| | roasted corn | | | |
| | oil | | | |
| | Oil and fat | | | 0.8 |
| | of (3) | | | |
| | linseed oil | | | |

| | | | |
|---|---|---|---|
| Allyl mercaptan | Control | 0.30 | 0.33 |
| Methyl 2-propenyl | | 0.88 | — |
| disulfide | | | |
| Methyl 2-propenyl | | — | 0.54 |
| trisulfide | | | |
| Dimethyl trisulfide | | 0.76 | — |
| Allyl disulfide | | 0.83 | 0.95 |
| Flavor evaluation | | Had | Had |
| | | desirable | desirable |
| | | flavor | flavor |

As shown in Table 4, by frying kara-age with the oil and fat compositions of Examples 4-1 and 4-2 containing the oil and fat of (1) or the oil and fat of (3) as component A, the amounts of allyl mercaptan, methyl 2-propenyl disulfide, methyl 2-propenyl trisulfide, dimethyl trisulfide, and allyl disulfide were lower than Control Example 4-1.

For the oil and fat of (1), an effect of reducing the sulfur-containing-compound content was obtained by including 0.4% by mass of roasted corn oil in the oil and fat composition.

For the oil and fat of (3), an effect of reducing the sulfur-containing-compound content was obtained by including 0.8% by mass of linseed oil in the oil and fat composition.

In the flavor evaluation as well, the kara-age fried using the oil and fat compositions of Examples 4-1 and 4-2 both had desirable flavor in comparison to Control Example 4-1.

### Examples 5-1 to 5-3

Table 5 shows the contents and evaluation results of the oil and fat compositions of Examples 5-1 to 5-3 and evaluation results.

TABLE 5

| | | Control | | | |
|---|---|---|---|---|---|
| | | Ex. 5-1 | Ex. 5-1 | Ex. 5-2 | Ex. 5-3 |
| Foodstuff | | Potato croquette | | | |
| Edible oil | Soybean oil | 100 | 99 | 99 | 93 |
| and fat | | | | | |
| (mass %) | | | | | |
| Component A | Oil and fat | | 1 | | |
| (mass %) | of (2) | | | | |
| | decoction | | | | |
| | corn oil | | | | |
| | Oil and fat | | | 1 | |
| | of (4) | | | | |
| | overheated | | | | |
| | corn oil | | | | |
| | Oil and fat | | | | 7 |
| | of (5) | | | | |
| | unrefined | | | | |
| | olive oil | | | | |

| | | | | |
|---|---|---|---|---|
| Dipropyl disulfide | Control | 0.74 | 0.92 | 0.91 |
| Methional | | 0.80 | 0.88 | 0.86 |
| Dimethyl trisulfide | | — | — | 0.61 |
| Flavor evaluation | | Had | Had | Had |
| | | desirable | desirable | desirable |
| | | flavor | flavor | flavor |

As shown in Table 5, by frying potato croquettes with the oil and fat compositions of Examples 5-1 to 5-3 containing the oil and fat of (2), the oil and fat of (4), or the oil and fat of (5) as component A, the amounts of dipropyl disulfide, methional, and dimethyl trisulfide were reduced in comparison to Control Example 5-1.

For the oil and fat of (2), an effect of reducing the sulfur-containing-compound content was obtained by including 1% by mass of decoction corn oil in the oil and fat composition.

For the oil and fat of (4), an effect of reducing the sulfur-containing-compound content was obtained by including 1% by mass of overheated corn oil in the oil and fat composition.

For the oil and fat of (5), an effect of reducing the sulfur-containing-compound content was obtained by including 7% by mass of unrefined olive oil in the oil and fat composition.

In the flavor evaluation as well, the potato croquettes fried using the oil and fat compositions of Examples 5-1 to 5-3 both had desirable flavor in comparison to Control Example 5-1.

### Examples 6-1 and 6-2

Table 6 shows the blending and evaluation results of the oil and fat compositions of Examples 6-1 and 6-2.

TABLE 6

| | | Control | | |
|---|---|---|---|---|
| | | Ex. 6-1 | Ex. 6-1 | Ex. 6-2 |
| Foodstuff | | Pork cutlet | | |
| Edible oil | Soybean oil | 100 | 99 | 93 |
| and fat | | | | |
| (mass %) | | | | |
| Component A | Oil and fat | | 1 | |
| (mass %) | of (4) | | | |
| | overheated | | | |
| | corn oil | | | |
| | Oil and fat | | | 7 |
| | of (5) | | | |
| | unrefined | | | |
| | olive oil | | | |

| | | | |
|---|---|---|---|
| Dimethyl trisulfide | Control | — | 0.61 |
| Methional | | 0.53 | 0.83 |
| Flavor evaluation | | Had | Had |
| | | desirable | desirable |
| | | flavor | flavor |

As shown in Table 6, by frying pork cutlets using the oil and fat compositions of Examples 6-1 and 6-2 containing the oil and fat of (4) or the oil and fat of (5) as component A, the amounts of dimethyl trisulfide and methional were lower than Control Example 6-1.

For the oil and fat of (4), an effect of reducing the sulfur-containing-compound content was obtained by including 1% by mass of overheated corn oil in the oil and fat composition.

For the oil and fat of (5), an effect of reducing the sulfur-containing-compound content was obtained by including 7% by mass of unrefined olive oil in the oil and fat composition.

In the flavor evaluation as well, the pork cutlets fried using the oil and fat compositions of Examples 6-1 and 6-2 both had flavor preferable to Control Example 6-1.

### Example 7-1

Table 7 shows the contents of the oil and fat composition of Example 7-1 and evaluation results.

TABLE 7

| | | Control | |
|---|---|---|---|
| | | Ex. 7-1 | Ex. 7-1 |
| Foodstuff | | Pork cutlet | |
| Edible oil | Soybean oil | 100 | 99 |
| and fat | | | |
| (mass %) | | | |
| Component A | Oil and fat | | 1 |
| (mass %) | of (4) | | |
| | overheated | | |
| | corn oil | | |

| | | |
|---|---|---|
| Methanethiol | Control | 0.83 |
| 1,2-Dimethyl sulfide | | 0.96 |
| Dimethyl trisulfide | | 0.56 |
| Flavor evaluation | | Had |
| | | desirable |
| | | flavor |

As shown in Table 7, by frying pork cutlets using the oil and fat composition of Example 7-1 containing the oil and fat of (4) as component A, the amounts of methanethiol, 1,2-dimethyl sulfide, and dimethyl trisulfide were lower than Control Example 7-1.

For the oil and fat of (4), an effect of reducing the sulfur-containing-compound content was obtained by including 1% by mass of overheated corn oil in the oil and fat composition.

In the flavor evaluation as well, the pork cutlets fried using the oil and fat composition of Example 7-1 had flavor preferable to Control Example 7-1.

The reduction method of the present invention is not limited to the embodiments and examples described above; various changes can be made without impairing the effects of the invention.

1. A method for reducing the sulfur-containing-compound content of volatile substances from fried food, wherein a foodstuff is fried using an oil and fat composition containing an edible oil and fat and the following component A.
Component A: One, two, or more oils and fats selected from (1) to (5) below.
(1) A roasted oil
(2) An oil and fat obtained through a production method including an addition step in which one, two, or more selected from oil stuff raw materials and products processed from the oil stuff raw materials are added to an edible oil and fat, and a heating step in which the oil and fat is heated at a heating temperature of more than 100° C. and 220° C. or less and for a heating time of 5 minutes or more and 240 minutes or less
(3) An oil and fat in which the amount of n-3 fatty acids contained in the total amount of constituent fatty acids is 30% by mass or more and 80% by mass or less
(4) An oil and fat obtained by performing a heat treatment of 120° C. or more on crude oil including either expressed oil of corn germ or extracted oil of corn germ, or on an oil and fat obtained via at least one step among a degumming step, a deacidification step, and a decolorization step in a step of refining the crude oil
(5) Olive oil

2. The method according to claim 1, wherein the component A is the oil and fat of (1), and
the component A content is 0.05% by mass or more and 3% by mass or less.

3. The method according to claim 1, wherein the component A is the oil and fat of (2), and
the component A content is 0.15% by mass or more and 6% by mass or less.

4. The method according to claim 1, wherein the component A is the oil and fat of (3), and
the component A content is 0.1% by mass or more and 5% by mass or less.

5. The method according to claim 1, wherein the component A is the oil and fat of (4), and
the component A content is 0.15% by mass or more and 6% by mass or less.

6. The method according to claim 1, wherein the component A is the oil and fat of (5), and
the component A content is 1% by mass or more and 15% by mass or less.

7. The method according to claim 1, wherein the sulfur-containing compound is one, two, or more selected from methanethiol, 1,2-dimethyl sulfide, dimethyl trisulfide, dipropyl disulfide, dipropyl trisulfide, methional, allyl mercaptan, allyl disulfide, methyl 2-propenyl disulfide, and methyl 2-propenyl trisulfide.

8. The method according to claim 1, wherein the foodstuff includes one, two, or more selected from livestock meat, fish meat, vegetable protein, vegetables, and products processed therefrom.
